(19) United States
(12) Patent Application Publication
(10) Pub. No.: US 2007/0227036 A1
(43) Pub. Date: Oct. 4, 2007

(54) Airflow Indicator for a Dryer Exhaust Vent

(76) Inventor: Owen Francis Powers, Chevy Chase, MD (US)

Correspondence Address: GREENBERG & LIEBERMAN, LLC, 2141 WISCONSIN AVE, N.W., SUITE C-2, WASHINGTON, DC, 20007, US

(21) Appl. No.: 11/308,465

(22) Filed: Mar. 28, 2006

(51) Int. Cl. D06F 58/00; F26B 11/02

(52) U.S. Cl. 34/606; 34/140

(57) ABSTRACT

An airflow indicator for detecting restricted airflow in a dryer exhaust vent. A lightweight semicircular baffle is placed on a rod inside a vertical exhaust vent and the airflow from the dryer pushes the baffle up in the open (vertical) position. Should the dryer exhaust vent have restricted or nonexistent airflow the baffle is in a closed (horizontal) position. The tab placed on the rod indicates whether the baffle is in an open or closed position.

### FIELD OF THE INVENTION

The present invention relates to an airflow indicator for a dryer exhaust vent.

### BACKGROUND OF THE INVENTION

In a conventional clothes drying machine, lint will often buildup, or for some other reason there will be restricted airflow from the dryer through the dryer's exhaust vent. Airflow indicators are known in the prior art, as are lint indicators, but the prior airflow indicators are generally not intended for use with conventional dryer exhaust vents; furthermore, a lint indicator only measures the amount of lint accumulated, and cannot indicate specifically if airflow in the exhaust vent of a dryer is restricted. There may be other reasons besides lint buildup that a dryer is inoperative, or that airflow is restricted.

U.S. Pat. No. 3,718,982 issued to Deaton on Mar. 6, 1973, shows an excess lint indicator for a clothes dryer. It comprises an excess lint indicating system including a visible signal light on the dryer when an excess amount of lint accumulates. Unlike the present invention it is not intended to show the airflow of a dryer's exhaust vent.

U.S. Pat. No. 3,880,110 issued to Loesch et al. on Apr. 29, 1975, is a shaft operation monitor. The rotational motion of the shaft operates an air pump, which generates a stream of air detected by a continuous airflow indicator, and interruption of the continuous rotation of the shaft is sensed by visual observation of the airflow indicator. Unlike the present invention, it is intended primarily for machines in the agricultural domain that have a rotating shaft.

U.S. Pat. No. 3,971,198 issued to Lane on Jul. 27, 1976, is a collector for a power lawnmower. A separator is mounted in the cover to separate the clippings and other solids from the air so that the exhaust air is substantially free of such solids as it passes through the exhaust. Unlike the present invention, it is not intended for use with a drying machine.

U.S. Pat. No. 4,206,552 issued to Pomerantz et al. on Jun. 10, 1980, is a means and method for controlling the operation of a drying apparatus. It is capable of accurately drying any number of articles to a desired degree of dryness. It is not, however, capable of monitoring and indicating airflow through the exhaust vent of a dryer.

U.S. Pat. No. 4,924,664 issued to Hicks et al. on May 15, 1990, is a ducted cover grass collection system for a lawnmower. An airflow indicator located in the hopper lid pivots when the airflow in the duct decreases, signaling that the hopper is filled with clippings. Unlike the present invention it is not intended for use with a drying machine.

U.S. Pat. No. 5,415,121 issued to Corlett on May 16, 1995, is an airflow indicator for sailboat sails. It allows for a viewer to determine the airflow conditions on both sides of a sailboat sail while viewing only one side.

U.S. Pat. No. 5,487,311 issued to Guativa et al. on Jan. 30, 1996, is an air velocity averaging rotor. It is intended to measure airflow in a conduit enabling the average flow velocity in the conduit to be determined with a single measurement. Unlike the present invention it is not meant to be used with a dryer.

U.S. Pat. No. 5,860,224 issued to Larson on Jan. 19, 1999, is a testing for blocked dryer vent. It is simply a test instrument inserted into a filter access port of a clothes dryer and senses a pressure difference between the front and back surfaces. Unlike the present invention, the testing must be done each time the dryer is inoperative, instead of being a device that is installed once and effectively eliminates service personnel from having to ascertain whether the dryer vent has restricted airflow each time it is inoperative.

U.S. Pat. No. 5,877,415 issued to Kruse on Mar. 2, 1999, is a laminar airflow detector to determine the presence and absence of laminar airflow on the face of an airfoil or sail. Unlike the present invention, it is not intended for use with a dryer.

U.S. Pat. No. 6,105,350 issued to Vachon et al. on Aug. 22, 2000, is a multi-port hopper exhaust apparatus for a grass-catcher. Unlike the present invention, it is not intended for use with a dryer.

U.S. Pat. No. 6,412,435 issued to Timmons, Jr. on Jul. 2, 2002, is a dirty filter indicator for use with a furnace or air conditioning assembly. Unlike the present invention it is not intended for use with a dryer.

U.S. Pat. No. 6,725,732 issued to Stein on Apr. 27, 2004, is a clothes dryer with a safety feature of lint airflow obstruction detection and an anemometer sensor grid detects airflow with a connected light. Unlike the present invention, Stein's patent requires more extensive installation as it comprises a series of electrically installed devices.

U.S. Pat. No. 6,766,633 issued to Wanie et al. is a yard waste hopper for a lawn tractor and method of using the same. Unlike the present invention it is not intended for use with a clothes dryer.

US Publication 2004/0263341 published for Enzinna on Dec. 30, 2004, is an airflow blockage detection apparatus for a permanent split-capacitor single-phase fan motor. It is intended for use with cooling fans. Unlike the present invention it is not intended for use with a dryer.

Thus, there is a need for a simple yet effective way of determining whether airflow is reduced or restricted in a clothes dryer exhaust vent. This would facilitate fixing an inoperative dryer for service personnel, and would also aid users in determining whether there is buildup of lint or some other restrictive object in the exhaust vent. There must be a way to indicate airflow in a clothes dryer vent that is easy to install and does not require extensive wiring or a complicated electrical setup.

### SUMMARY OF THE INVENTION

In view of the disadvantages of the prior art as discussed above, the present invention provides an improved, efficient airflow indicator for a dryer that is easily installed and maintained and overcomes the drawbacks of the prior art.

The present invention essentially comprises a semi-circular disc, or a baffle, with a rod protruding from either side on the distal end of the disc. When there is not enough airflow, the baffle will automatically be in a horizontal position and the rods will point sideways. When there is sufficient airflow, the rods on either side of the baffle point up.

It is an object of the present invention to provide for an apparatus that is simple and easy to install but can efficiently indicate whether there is enough air flow in the dryer exhaust vent.

It is an object of the present invention to provide for such a device that is easy and inexpensive to manufacture, which can also be made quickly in order to reduce cost of production.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an environmental view of the present invention in the open position in the dryer exhaust vent.

FIG. 2 is an environmental view of the present invention in the closed position in the dryer exhaust vent.

FIG.3 is an environmental view of the present invention as it would be placed in the dryer exhaust vent.

The same reference numerals refer to the same parts throughout the various figures.

### DETAILED DESCRIPTION OF THE PREFERRED EMBODIMENT

The present invention is a baffle 15 positioned in the path of airflow. The baffle 15 moves about an axis such that the baffle 15 is in the plane of the airflow when air is flowing, and is in a plane perpendicular to the airflow when air is not flowing. In a first embodiment of the present invention, the baffle 15 is only on one side of the axis (preferably in a semi-circular shape, but the baffle 15 could have any form that fits within the diameter of the dryer exhaust vent, and it could also be weighted); in a second embodiment of the present invention, the baffle 15 is on both sides of the axis and it is merely weighted, which controls the axis of rotation. This second embodiment could have various configurations in terms of surface area.

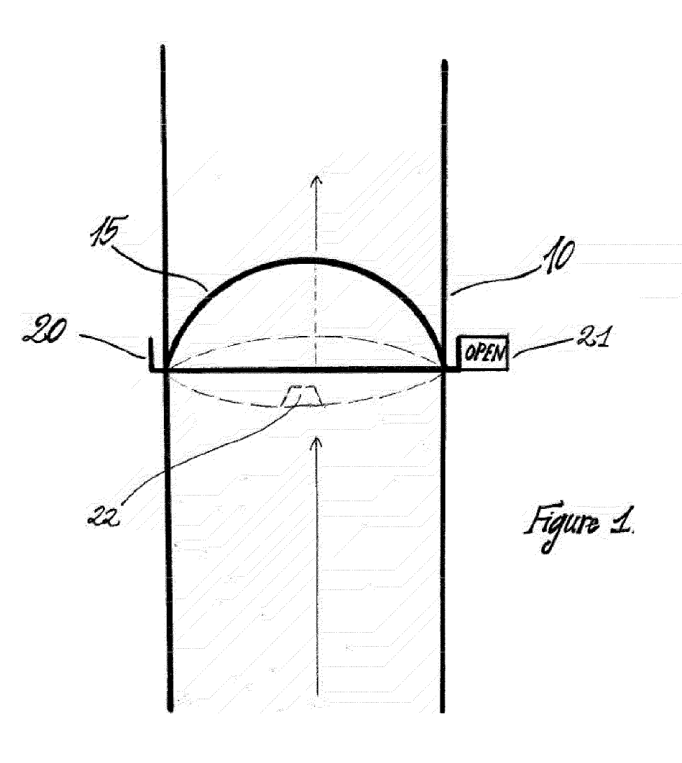

The preferred embodiment, as shown in FIG. 1, comprises a baffle 15 is placed within a vertical dryer exhaust vent 10. Preferably the baffle 15 is a semi-circular disc with a 1/16″ diameter rod 20. The baffle 15 is installed in an existing vertical duct of the dryer exhaust vent 10. The rod 20 of the baffle 15 will point up when there is sufficient airflow (as denoted by the arrows in FIG. 1), because the pressure of the air coming from the dryer will push against the side of the baffle 15 and force it up, in a vertical “open” position. There can be included a tab 21 to indicate whether the baffle 15 is open or closed. The tab 21 to indicate airflow would be at the end of the rod 20. It would show red (or CLOSED) when off or when on and clogged, otherwise it would show the green side (ON) when on and air is flowing through the duct 10. There is also a baffle stop 22 on both sides of the vent 10 to prevent the baffle 15 from falling down below the horizontal closed position. To prevent the baffle 15 from becoming stuck in the vertical position (because of an accumulation of dust or other cause for not allowing the baffle 15 to fall back in the horizontal position), the rods 20 will be well-oiled and/or the baffle 15 could be slightly weighted. It is therefore specific for a dryer vent 10.

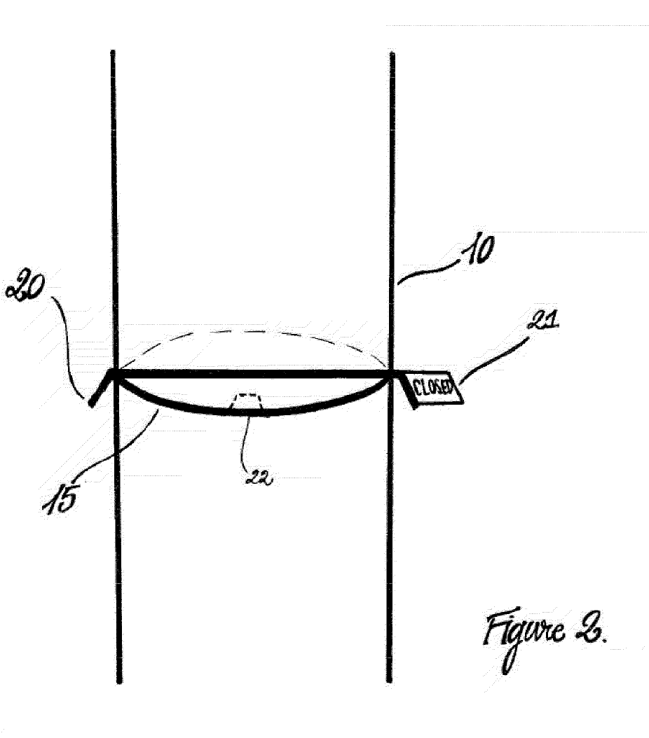

As shown in FIG. 2, the preferred embodiment of the rod 20 of the baffle 15 will point horizontally when the dryer is off or when the dryer is on and airflow is restricted, because there is no air pushing against the side of the baffle 15; when the rod 20 points horizontally, the baffle 15 is therefore in the horizontal “closed” position. Airflow from the dryer pushes the baffle 15 up in the open (vertical) position. Should the dryer exhaust vent 10 have restricted or nonexistent airflow the baffle 15 is in a closed (horizontal) position. Regular homeowners can install the baffle unit 15 themselves. The airflow indicator baffle 15 is non-flammable and light enough to be lifted by the airflow of the dryer. Tab 21 indicates the baffle 15 is in a closed position.

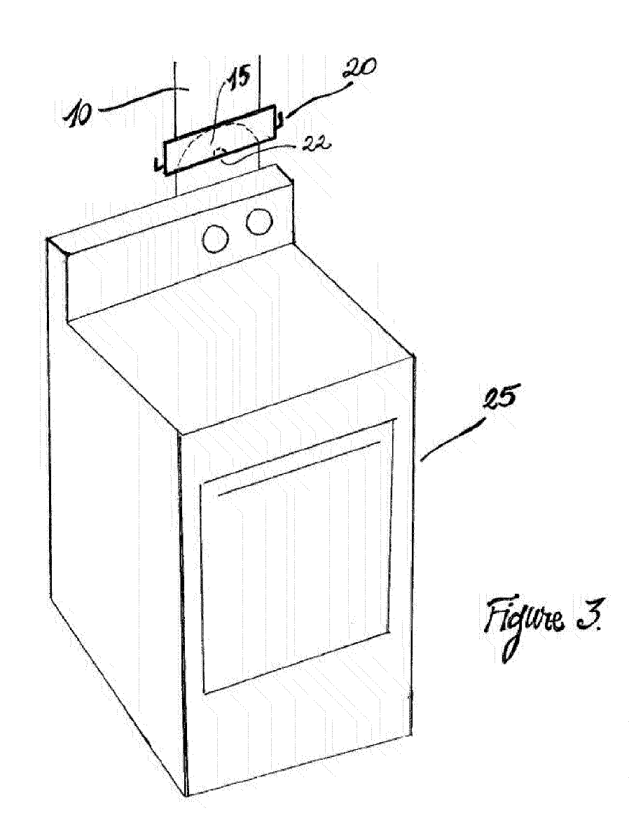

As shown in FIG. 3, once installed, the preferred embodiment makes it easy to view/reach the rods 20 without having to move the dryer 25. Only the rods 20 are visible once the baffle 15 is completely installed. The baffle 15 is contained in either a short piece of duct or a box configuration that is attached in an existing duct 10 by cutting the duct 10 and inserting the piece containing the baffle 15. Attaching the piece to the dryer duct 10 just above the top of the dryer, one is able to see the rods 20 on the side go up when air flows through the duct 10. An optional embodiment would include having a cap that comes off the side of the baffle and box configuration, so that a vacuum cleaner hose could be inserted or attached. When a user realizes that the dryer duct is clogged, they can try cleaning it by simply using a vacuum cleaner. If that does not fix the problem, they can take further steps like calling in a repair person to perform the maintenance.

If a user has a horizontal dryer exhaust vent, then when there is sufficient airflow the baffle 15 would be in a horizontal position, and when there is none or restricted airflow the baffle 15 would be in a vertical position (it would simply drop to the vertical position).

Preferably the baffle 15 is semi-circular. The surface area of the baffle 15 must have a smaller area than the area of the dryer vent 10. However, in a second embodiment, if the baffle 15 is divided by a hypothetical line from one end of the rod 20 to the other, a first section of the baffle 15 on one side of the hypothetical line must have a non-equivalent surface area when compared to the second section of the baffle 15 on the other side of the hypothetical line.

This alternative embodiment is where the baffle 15 is divided by a hypothetical line from one end of the rod 20 to the other, and one half of the baffle 15 on one side of the hypothetical line must have a non-equivalent weight when compared to the other half of the baffle 15 on the other side of the hypothetical line. More weight on a first section versus a second section would allow the baffle to move into a plane parallel to the airflow even if the surface area of the first section is identical to the surface area of the second section.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A device to indicate airflow in a dryer exhaust vent, comprising:
A baffle;
A rod in communication with said baffle.

2. A device to indicate airflow in a dryer exhaust vent, comprising:
A baffle;
A rod in communication with said baffle;
A first section of the baffle in communication with said rods; and
A second section of the baffle in communication with said first section of the baffle, which has a non-equivalent weight to said first section of a baffle.

3. A device to indicate airflow in a dryer exhaust vent, comprising:
A baffle;
A rod in communication with said baffle;
A first section of the baffle in communication with said rods; and
A second section of the baffle in communication with said first section of the baffle, which has a non-equivalent surface area to said first section of a baffle.

4. The device of claim 1 wherein said baffle is configured to move in a plane parallel to the travel of airflow in the dryer exhaust vent.

5. The device of claim 1 wherein said rod is configured to be in communication with the diameter of said baffle.

6. The device of claim 1 wherein said rod has 90-degree angles on both ends.

7. The device of claim 1 wherein said baffle and said rod are configured to be placed within the dryer exhaust vent above the dryer.

8. The device of claim 1 wherein said baffle and said rod are configured to indicate airflow in the dryer exhaust vent based upon the position of said baffle within the exhaust vent.

9. The device of claim 2 wherein said baffle is configured to move in a plane parallel to the travel of airflow in the dryer exhaust vent.

10. The device of claim 2 wherein said rod is configured to be in communication with the diameter of said baffle.

11. The device of claim 2 wherein said rod has 90-degree angles on both ends.

12. The device of claim 2 wherein said baffle and said rod are configured to be placed within the dryer exhaust vent above the dryer.

13. The device of claim 2 wherein said baffle and said rod are configured to indicate airflow in the dryer exhaust vent based upon the position of said baffle within the exhaust vent.

14. The device of claim 3 wherein said baffle is configured to move in a plane parallel to the travel of airflow in the dryer exhaust vent.

15. The device of claim 3 wherein said rod is configured to be in communication with the diameter of said baffle.

16. The device of claim 3 wherein said rod has 90-degree angles on both ends.

17. The device of claim 3 wherein said baffle and said rod are configured to be placed within the dryer exhaust vent above the dryer.

18. The device of claim 3 wherein said baffle and said rod are configured to indicate airflow in the dryer exhaust vent based upon the position of said baffle within the exhaust vent.
